(19) United States
(12) Patent Application Publication
(10) Pub. No.: US 2007/0161510 A1
(43) Pub. Date: Jul. 12, 2007

(54) TEMPERATURE RESPONSIVE COMMUNICATION DEVICE

(76) Inventors: Larry Kurt Spitzer, Midlothian, TX (US); Jimmy Joe Spitzer, Waxahachie, TX (US)

Correspondence Address: Michael A. O'Neil;Michael A. O'Neil, P.C., Suite 820, 5949 Sherry Lane, Dallas, TX, 75225, US

(21) Appl. No.: 11/620,212

(22) Filed: Jan. 5, 2007

Related U.S. Application Data
(60) Provisional application No. 60/757,767, filed on Jan. 10, 2006.

(51) Int. Cl. B41M 5/40

(52) U.S. Cl. 503/226

(57) ABSTRACT

The present invention comprises a device for revealing a message or image responsive to temperature changes of approximately 5° F. (3° C.). A thermochromic leuco dye is applied to a surface that is positioned for contact by an outside heating or cooling source. The thermochromic leuco dye reveals an intended message or image when the temperature is changed sufficiently.

### CROSS-REFERENCE TO RELATED APPLICATIONS

This application claims priority based on provisional patent application Ser. No. 60/757,767 filed Jan. 10, 2006, the entire content of which is incorporated herein by reference.

### TECHNICAL FIELD

This invention relates generally to the use of thermochromic leuco dyes on surfaces for revealing a message when the temperature of the dye is changed by a predetermined amount.

### BACKGROUND AND SUMMARY OF THE INVENTION

Thermochromic leuco dyes (“LDs”) are well known and are characterized as changing from a specified color to an invisible or clear appearance when their temperature is raised approximately 5° F. (3° C.), and changing back to the specified color when the temperature drops back down. LDs can be found in a variety of forms, including powders, slurries, and water-based inks.

LDs have been used to indicate a rise in temperature in items as diverse as battery testers, microwave sensors, and Nerf® footballs. The LDs in the battery testers have been used to indicate the power remaining in the battery. The LDs in the microwave sensors have been used to indicate that a substance has been warmed to the desired temperature. And LDs have been used as mere novelties in things such as Nerf® footballs to display a different color when touched by a human hand.

But LDs have not been used to reveal images or communicate messages to an intended recipient, as is disclosed in the present application. More specifically, the present invention comprises a surface for application of a LD, wherein the surface is positioned so as to be contacted by an outside heating source to reveal an intended image or message when the temperature is changed sufficiently.

### BRIEF DESCRIPTION OF THE DRAWINGS

A more complete understanding of the present invention may be had by reference to the following Detailed Description when taken in connection with the accompanying Drawings, wherein:

FIG. 1 is a perspective view of the first embodiment of the present invention wherein a thermochromic leuco dye is applied to a surface comprising a urinal mat;

FIG. 2A is a perspective view of the surface of the urinal mat shown in FIG. 1 prior to being contacted by the heating source;

FIG. 2B is a perspective view of the surface of the urinal mat shown in FIG. 1 while being contacted by the heating source, and showing the message being revealed;

FIG. 3 is a perspective view of a second embodiment of the present invention, showing a surface upon which a thermochromic leuco dye is applied on a standard urinal mat having a deodorant cake within an enclosure;

FIG. 4 is a perspective view of a third embodiment of the present invention, showing a surface upon which a thermochromic leuco dye is applied being positioned within a standard toilet to assist in toilet-training young males; and

FIG. 5 is front view of a fourth embodiment of the present invention, showing a surface upon which a thermochromic leuco dye is applied being positioned on a standard automobile dashboard.

### DETAILED DESCRIPTION

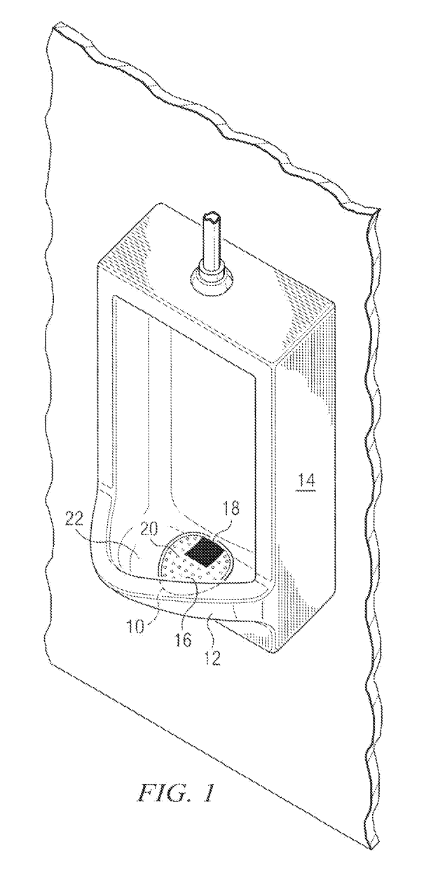

Referring now to the drawings, an in particular to FIG. 1, a urinal mat 10 is shown positioned over an opening of a drain 12 of a urinal 14. The urinal mat 10 comprises a plurality of perforations 16 for facilitating the evacuation of the contents of the urinal 14 through the drain 12. The urinal mat 10 may be constructed of any substance that is impermeable to liquid, such as plastic or rubber, so that the urinal mat 10 does not retain the liquids that are directed thereonto by an individual who is using the urinal 14. An layer of thermochromic leuco dye 18 is applied to the surface 20 of the urinal mat 10. Techniques for applying layers of thermochromic leuco dye onto substances that are impermeable to liquid are well known in the art. The urinal mat 10 is positioned over the drain 12 in the lower portion of the mouth 22 of the urinal 14 so that the urinal mat 10 is positioned to receive urine that is directed thereon by an individual.

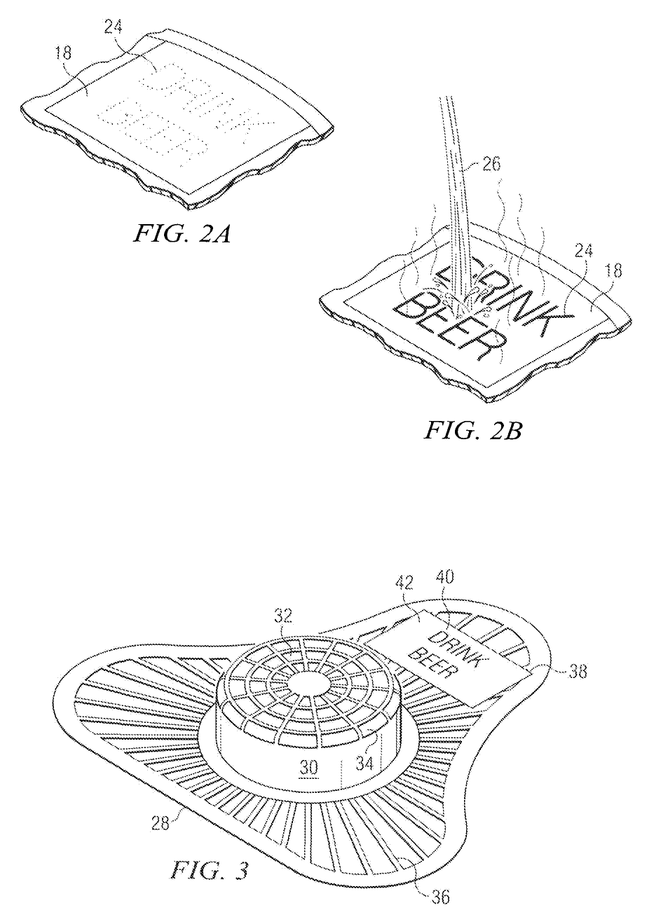

Referring to FIG. 2A, the portion of the urinal mat 10 having the layer of thermochromic leuco dye 18 is shown. The temperature of the layer of thermochromic leuco dye 18 has not been raised by an outside source, and is shown applied on top of a message 24 that cannot be seen by an observer due to the layer of thermochromic leuco dye 18, which is a color of the designer's choice.

Referring to FIG. 2B, the same portion of the urinal mat 10 is shown, but the temperature of the layer of thermochromic leuco dye 18 has been raised by an outside source 26 to reveal the message 24 that is printed underneath the layer of thermochromic leuco dye 18. After the outside source 26 ceases to be applied to the layer of thermochromic leuco dye 18 to reveal the message 24 underneath, the temperature of the urinal mat 10 and layer of thermochromic leuco dye 18 will drop and the layer of thermochromic leuco dye will again conceal the message 24 from a viewer.

Referring to FIG. 3, there is shown a standard urinal mat 28 as is commonly used in urinals such as the one depicted in FIG. 1. The urinal mat 28 comprises an enclosure 30 having baffles 32 that retain a deodorant cake 34, wherein the enclosure 30 sits on a base 36, and wherein the base 36 comprises a surface 38 upon which a message or image 40 is made with a layer 42 of thermochromic leuco dye covering the image 40. The urinal mat 28 is made of a substance impermeable to liquid, such as plastic or rubber. As in the first embodiment shown in FIGS. 1, 2A, and 2B, the layer 42 changes from color to an invisible or clear appearance upon the application of an outside heating source to reveal the message or image 40 below.

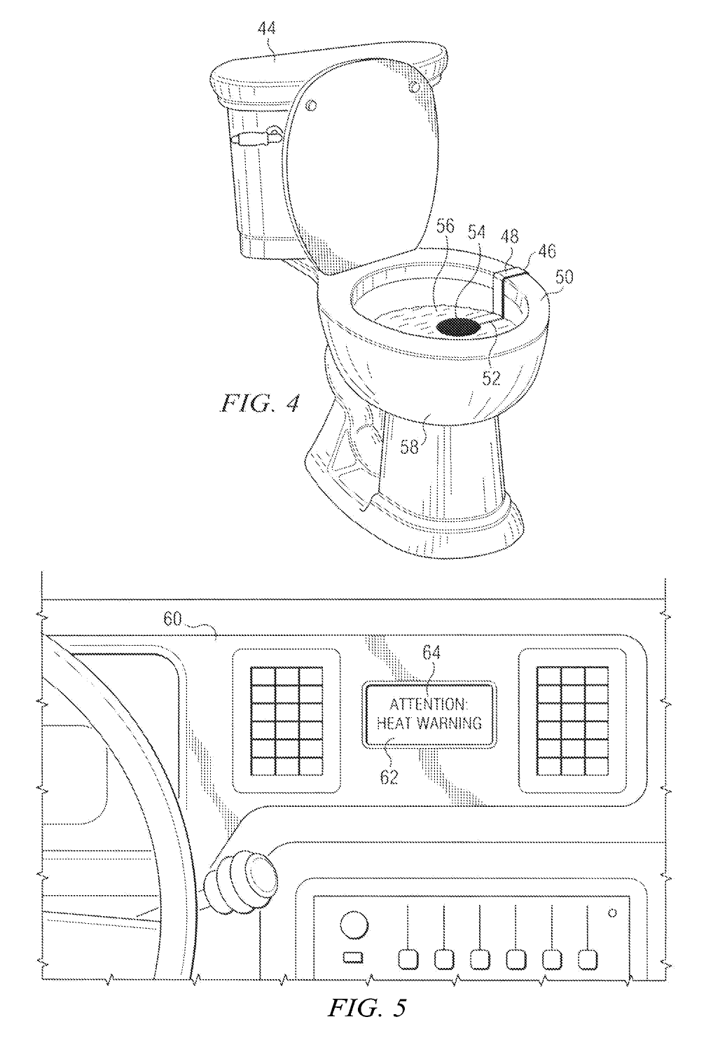

Referring to FIG. 4, there is shown a standard toilet 44 having a device 46 for assisting in the toilet-training of young males. The device 46 comprises a hook 48 for attaching the device 46 to the ledge 50 of the toilet 44, an arm 52, and a surface 54 upon which a message or image is printed under a layer of thermochromic leuco dye. The device 46 is positioned such that the surface 54 is located at or near the waterline 56 inside the bowl 58 of the toilet 44. The purpose of the device 46 is to provide a target for a young male to aim towards when learning to urinate inside a toilet. If the urine hits the surface 54 the temperature of the layer of thermochromic leuco dye will be raised and will become invisible so that the message or image underneath is revealed, allowing the young male to know that he has hit his target.

Referring to FIG. 5, a dashboard 60 inside a motor vehicle is shown having a surface 62 wherein a message 64 is printed underneath a layer of thermochromic leuco dye. The layer of thermochromic leuco dye will change from a color to a clear or invisible appearance when it is heated, for example by the sun, revealing a message underneath that may be a warning to not leave children or animals unattended inside the vehicle.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. A temperature responsive communication device, comprising:
a surface;
an image formed on the surface;
a layer of a thermochromic leuco dye applied to the surface for normally covering the image;
wherein the thermochromic leuco dye changes color when the temperature of the thermochromic leuco dye is changed to reveal the image.

2. The temperature responsive communication device according to claim 1 further comprising:
a mat for a urinal having a drain;
the mat having a top side that is positioned to receive urine; and
wherein the top side of the mat comprises the surface having the layer of thermochromic leuco dye extending thereover.

3. The temperature responsive communication device according to claim 2, wherein the mat further comprises a unitary piece of flexible material of uniform thickness having perforations to facilitate draining.

4. The temperature responsive communication device according to claim 1 further comprising:
a mat for a urinal having a drain, wherein the mat comprises a base, and an enclosure attached to the base containing a deodorant cake.

5. A temperature responsive communication device, comprising:
a toilet having a rim;
a device attached to the rim of the toilet and extending inwardly therefrom;
a surface positioned on the device at a location remote from the rim of the toilet;
an image formed on the surface; and
a layer of thermochromic leuco dye applied to the surface to cover the image wherein the thermochromic leuco dye changes color when the temperature of the thermochromic leuco dye is changed to reveal the image.

6. A temperature responsive communication device, comprising:
a surface positioned within a vehicle;
an image printed on the surface; and
a layer of thermochromic leuco dye applied to the surface to cover the image wherein the thermochromic leuco dye changes color when the temperature of the thermochromic leuco dye is changed to reveal the image.
